(19) United States
(12) Patent Application Publication
(10) Pub. No.: US 2026/0138004 A1
(43) Pub. Date: May 21, 2026

(54) CONTROL DEVICE AND CONTROL DEVICE KIT

(71) Applicant: DEXIN CORPORATION, New Taipei City (TW)

(72) Inventors: HO-LUNG LU, NEW TAIPEI CITY (TW); Yi-Chen Liu, New Taipei City (TW); Tung-Chi Tsai, New Taipei City (TW)

(21) Appl. No.: 19/332,019

(22) Filed: Sep. 17, 2025

Related U.S. Application Data
(60) Provisional application No. 63/767,575, filed on Mar. 6, 2025.

(30) Foreign Application Priority Data
Nov. 20, 2024 (TW) 113144556
Jun. 25, 2025 (TW) 114123826

(51) Int. Cl. A63F 13/24; A63F 13/23

(52) U.S. Cl. CPC A63F 13/24; A63F 13/23

(57) ABSTRACT

A control device and a control device kit. The control device includes two gripping parts and a power supply module. The power supply module includes a rechargeable battery, at least one power supply electrical connection structure, and an external electrical connection structure. The external electrical connection structure is connected with an external power supply device, allowing the external power supply device to charge the rechargeable battery. the gripping electrical connection structure can engage with the power supply electrical connection structure, so that the two gripping parts can obtain power supplied by the rechargeable battery. The two gripping engaging structures can also engage with plate engaging structures provided on both sides of the support plate, allowing the two gripping parts to be connected to each other through the plate engaging structures. The two gripping parts and the support plate can jointly hold the electronic device.

### CROSS-REFERENCE TO RELATED PATENT APPLICATION

This application claims the benefit of priorities to Taiwan Patent Applications No. 113144556, filed on Nov. 20, 2024, and No. 114123826, filed on Jun. 25, 2025. The entire content of the above identified application is incorporated herein by reference.

This application claims the benefit of priority to the U.S. Provisional Patent Application Ser. No. 63/767,575, filed on Mar. 6, 2025, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a control device, and more particularly to a control device that is configured to replace a power supply module.

### BACKGROUND OF THE DISCLOSURE

In conventional control grips commonly used for holding smartphones and tablet computers, a battery is disposed inside the control grip. However, this battery cannot be easily replaced, which can lead to environmental issues. Similarly, a battery of conventional game controllers is disposed inside of the game controller, and likewise cannot be easily replaced.

In the above-mentioned conventional control grips or conventional game controllers, when the control grip runs out of power, a user can only connect the control grip to a power supply device through an electrical connection wire. As a result, this causes inconvenience in use, especially when the user is operating the control grip.

### SUMMARY OF THE DISCLOSURE

In response to the above-referenced technical inadequacy, the present disclosure provides a control device primarily for improving upon conventional control grips, which do not permit the user to replace the battery and thus cause related issues.

In order to solve the above-mentioned problems, one of the technical aspects adopted by the present disclosure is to provide a control device. The control device includes two gripping parts and a power supply module. Each of the gripping parts has a plurality of operating members. An inside of each of the gripping parts has a gripping engaging structure and a gripping electrical connection structure. No power supply unit is disposed inside each of the gripping parts. The power supply module including a main body, a rechargeable battery, at least one power supply electrical connection structure, and an external electrical connection structure. Two opposite sides of the main body each have an auxiliary engaging structure. The rechargeable battery is disposed in the main body. The at least one power supply electrical connection structure is disposed on the main body and is electrically connected to the rechargeable battery. The external electrical connection structure is configured to connect an external power supply device, such that the external power supply device is configured to charge the rechargeable battery. The gripping engaging structure of each of the gripping parts is configured to be engaged with the auxiliary engaging structure. The gripping electrical connection structure is configured to be engaged with the power supply electrical connection structure, such that the two gripping parts are configured to obtain electrical power provided by the rechargeable battery. The two gripping engaging structures of the two gripping parts are configured to be engaged with the plate engaging structures that are respectively disposed on both sides of a support plate, whereby the two gripping parts are configured to be engaged with each other through the plate engaging structures, and the two gripping parts and the support plate are configured to jointly hold an electronic device.

In order to solve the above-mentioned problems, another one of the technical aspects adopted by the present disclosure is to provide a control device kit. The control device kit includes two gripping parts, a power supply module, and a support plate. Each of the gripping parts has a plurality of operating members. An inside of each of the gripping parts has a gripping engaging structure. The inside of at least one of the gripping parts has a gripping electrical connection structure. No power supply unit is disposed inside each of the gripping parts. The power supply module including a main body, a rechargeable battery, and at least one power supply electrical connection structure. Two opposite sides of the main body each have an auxiliary engaging structure. The rechargeable battery is disposed in the main body. The at least one power supply electrical connection structure is disposed on the main body and is electrically connected to the rechargeable battery. Both sides of the support plate respectively have a plate engaging structure. The two gripping engaging structures of the two gripping parts are configured to be engaged with the two plate engaging structures. The two gripping parts and the support plate that are connected to each other are configured to jointly hold an electronic device. The gripping engaging structure of each of the gripping parts is configured to be engaged with the auxiliary engaging structure, and the gripping electrical connection structure is configured to be engaged with the power supply electrical connection structure, such that the two gripping parts are configured to obtain electrical power provided by the rechargeable battery.

Therefore, in the control device and the control device kit provided by the present disclosure, by virtue of the design of the power supply module and the two gripping parts, together with the gripping engaging structure, the gripping electrical connection structure, the auxiliary engaging structure, and the power supply electrical connection structure, the user can easily and conveniently replace the power supply module by themselves.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 and FIG. 2 are schematic assembled views of a control device from different perspectives, respectively, according to a first embodiment of the present disclosure;

FIG. 3 and FIG. 4 are schematic exploded views of the control device from different perspectives, respectively, according to the first embodiment of the present disclosure;

FIG. 5 is a schematic view showing an assembly of two gripping parts and a support plate of the control device according to the present disclosure;

FIG. 6 and FIG. 7 are schematic exploded views of the two gripping parts and the support plate of the control device from different perspectives according to the first embodiment of the present disclosure;

FIG. 8 is a schematic view showing an assembly of the two gripping parts and the support plate of a second embodiment of the control device according to the present disclosure;

FIG. 9 is a schematic view showing an assembly of the two gripping parts and the support plate of a third embodiment of the control device according to the present disclosure;

FIG. 10 is a schematic view of a control device kit according to the present disclosure;

FIG. 11 is a schematic view of the control device according to a fourth embodiment of the present disclosure;

FIG. 12 and FIG. 13 are schematic exploded views of the control device from different perspectives, respectively, according to the fourth embodiment of the present disclosure;

FIG. 14 is a schematic view of the control device according to a fifth embodiment of the present disclosure;

FIG. 15 and FIG. 16 are schematic exploded views of the control device from different perspectives, respectively, according to a sixth embodiment of the present disclosure;

FIG. 17 is a schematic view of the control device according to the sixth embodiment of the present disclosure; and

FIG. 18 is a schematic view of a control device kit according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

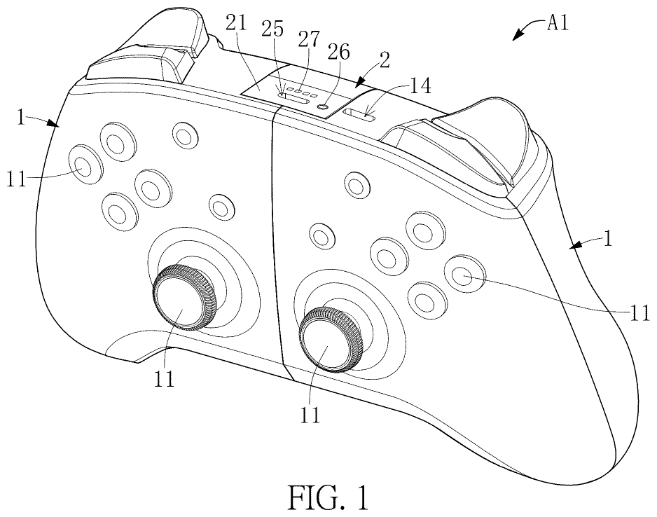

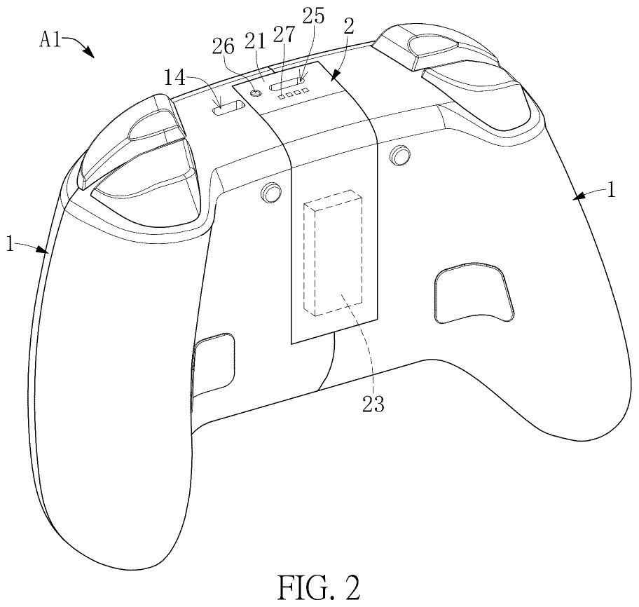

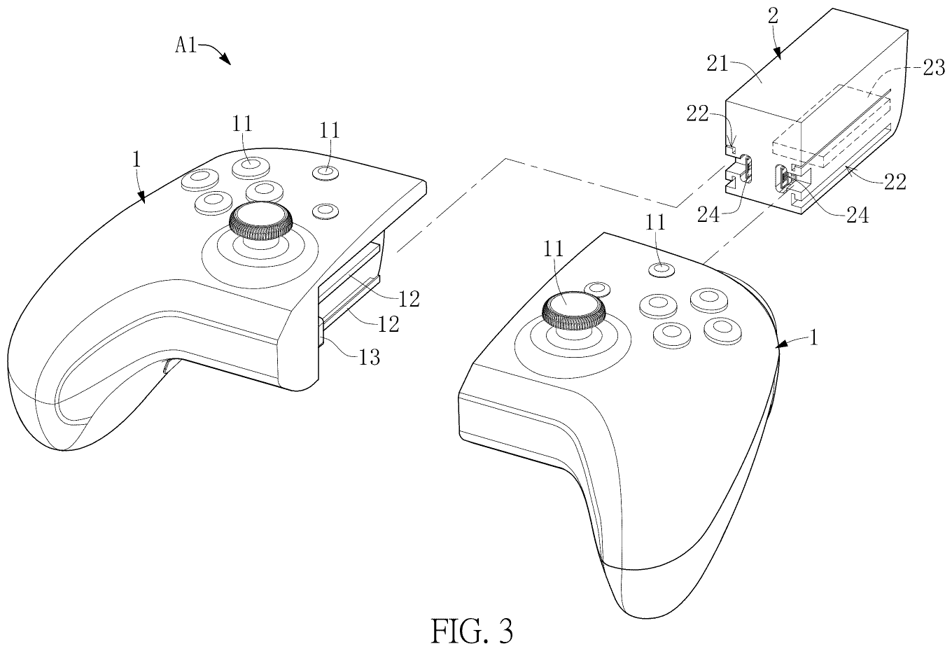

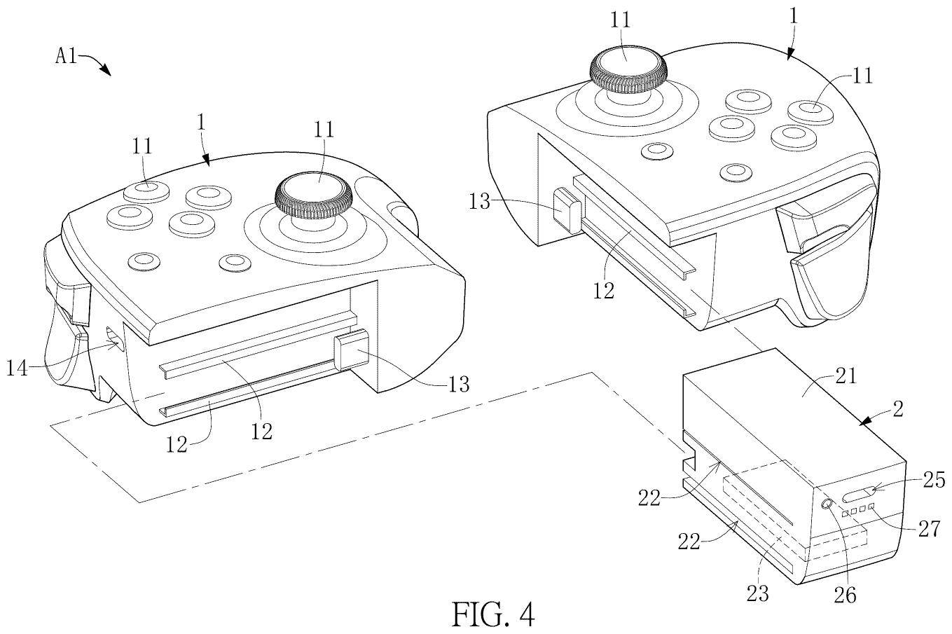

Referring to FIG. 1 to FIG. 4, FIG. 1 and FIG. 2 are schematic assembled views of a control device from different perspectives, respectively, according to a first embodiment of the present disclosure, and FIG. 3 and FIG. 4 are schematic exploded views of the control device from different perspectives, respectively, according to the first embodiment of the present disclosure.

A control device A1 of the present disclosure includes two gripping parts 1 and a power supply module 2. The two gripping parts 1 are detachably connected to the power supply module 2. The two gripping parts 1 and the power supply module 2 are connected to each other to form a full-sized control handle. In one of the embodiments, after the two gripping parts 1 are connected to the power supply module 2, top surfaces of the two gripping parts 1 are configured to completely cover the power supply module 2. In other words, when a user holds the control device A1 in a normal manner, the power supply module 2 is not visible.

When the two gripping parts 1 are engaged with the power supply module 2, the power supply module 2 is positioned between the two gripping parts 1, and the power supply module 2 is configured to provide electric power required for operation of each of the gripping parts 1. No power supply unit is disposed inside each of the gripping parts 1. That is to say, the inside of each gripping part 1 does not have a rechargeable battery. The inside of the power supply module 2 includes a rechargeable battery.

By configuring the inside of each of the gripping parts 1 to be without the battery and the inside of the power supply module 2 to have the rechargeable battery, the power supply module 2 can be designed to be detachable from the two gripping parts 1, such that the control device A1 is configured to achieve the effect of being able to replace the battery. Accordingly, this design allows for compliance with relevant European battery regulations.

In the conventional technology, the rechargeable battery is typically installed inside the control grips (or game controllers). With such a design, when the rechargeable battery ages, the rechargeable battery may swell, leak, or have other problems, which may damage electronic components around the rechargeable battery, thereby rendering the entire control grips (or game controllers) unusable. The control device A1 of the present disclosure is designed without any power supply unit (e.g., a rechargeable battery) inside each of the gripping parts 1, thereby effectively overcoming the problems associated with conventional control grips (or game controllers).

Furthermore, by designing the two gripping parts 1 and the power supply module 2 to be detachable, the user can replace the power supply module 2 at any time. In the conventional technology, when the control grip runs out of power, the user must charge the control grip (or game control grip) through an electrical connection wire, which causes inconvenience in use.

Each of the gripping parts 1 has a plurality of operating members 11. In practice, a portion of the operating members 11 are configured as buttons, a portion of the operating members 11 are configured as joysticks, a portion of the operating members 11 are configured as touchpads, and the operating members 11 can be selected according to actual requirements.

An inside of each of the gripping parts 1 has a gripping engaging structure 12 and a gripping electrical connection structure 13. The gripping electrical connection structure 13 is configured as various types of electrical connectors, such as USB Type-C, but the present disclosure is not limited thereto.

The power supply module 2 includes a main body 21, two auxiliary engaging structures 22, a rechargeable battery 23, at least one power supply electrical connection structure 24, and an external electrical connection structure 25. Two opposite sides of the main body each have an auxiliary engaging structure 22. The auxiliary engaging structure 22 is configured to be engaged with the gripping engaging structure 12 of the gripping parts 1.

In one of the embodiments, the auxiliary engaging structure 22 and the gripping engaging structure 12 are respectively configured as a sliding groove structure and a rail structure, and the user can easily engage or disengage the gripping part 1 and the power supply module 2 with each other without the need for any tools. In one of the embodiments, the auxiliary engaging structure 22 and the gripping engaging structure 12 are respectively configured as the rail structure and the sliding groove structure.

The rechargeable battery 23 is disposed in the main body 12. The power supply electrical connection structure 24 is disposed on the main body 21, and the power supply electrical connection structure 24 is electrically connected to the rechargeable battery 23. The power supply electrical connection structure 24 and the gripping electrical connection structure 13 are configured as electrical connectors that are configured to be engaged with each other. That is to say, one of the two electrical connectors is a male connector, and another one of the two electrical connectors is a female connector. As for the power supply electrical connection structure 24 and the gripping electrical connection structure 13, specific types of electrical connectors are not limited herein and can be designed according to actual requirements. For example, the power supply electrical connection structure 24 and the gripping electrical connection structure 13 are configured respectively as a USB Type-C plug and a USB Type-C receptacle.

It should be noted that, the power supply electrical connection structure 24 and the gripping electrical connection structure 13 are not limited to the electrical connector shown in the drawing. In different embodiments, the power supply electrical connection structure 24 and the gripping electrical connection structure 13 can respectively include a plurality of metal contacts. When the two gripping parts 1 and the power supply module 2 are connected to each other, the metal contacts of the power supply electrical connection structure 24 and the metal contacts of the gripping electrical connection structure 13 come into contact with each other.

The external electrical connection structure 25 is disposed on the main body 21. The external electrical connection structure 25 is configured as various types of electrical connectors, and the external electrical connection structure 25 is configured to connect an external power supply device (e.g., a computer, a power bank, etc.) through an electrical connection wire, such that the external power supply device 25 is configured to charge the rechargeable battery 23 of the power supply module 2 through the electrical connection wire. In different embodiments, the external electrical connection structure 25 can also be configured as a plurality of metal contacts. The power supply module 2 is configured to contact the metal contacts of the external power supply device (e.g., a specially designed battery charging base) through these metal contacts. Thus, the external power supply device is configured to charge the rechargeable battery 23 in the power supply module 2 through the metal contacts. Naturally, in one of the embodiments, the power supply module 2 includes two types of the external electrical connection structures 25, one of the external electrical connection structures 25 is an electrical connector, and another one of the external electrical connection structures 25 is a plurality of metal contacts.

As shown in FIG. 1 to FIG. 2, when the gripping engaging structures 12 of the respective gripping parts 1 and the auxiliary engaging structures 22 are engaged with each other, and the gripping electrical connection structure 13 and the power supply electrical connection structure 24 are also engaged with each other, the two gripping parts 1 are configured to obtain electrical power by the rechargeable battery 23 in the power supply module 2. In one of the embodiments, a switch unit 26 and an electrical quantity display unit 27 are disposed on the main body 21 of the power supply module 2. The switch unit 26 is configured to be operated by the user, so as to enable or disable the power supply module 2 to start or stop supplying the electrical power to the two gripping parts 1. The electrical quantity display unit 27 is configured to display electrical quantity of the rechargeable battery 23. By the design of the switch unit 26 and the electric quantity display unit 27, the user can clearly know the electrical quantity of the rechargeable battery of the power supply module 2 and current power supply status.

In one of the embodiments, an electrical connector 14 is disposed on at least one of the gripping parts 1, the electrical connector 14 is configured to be connected to an electrical connection wire, and the gripping part 1 is configured to obtain the electrical power, transmit information, or receive information through the electrical connection wire. The electrical power is obtained by the electrical connector through the electrical connection wire, and the electrical power is configured to be transmitted to another gripping part 1 through the power supply module 2, and the electrical power required for operation of the two gripping parts 1 is configured to be obtained through the electrical connector 14 and the electrical connection wire.

More specifically, the electrical connector 14 is configured as various types of USB connectors. When the electrical power provided by the power supply module 2 is insufficient, the user can insert one end of the electrical connection wire into the electrical connector 14 of the gripping part 1, and another one end into a power supply equipment (e.g., the power bank, the computer, etc.). In this way, the two gripping parts 1 are configured to obtain the electrical power required for operation through the electrical connection wire and the electrical connector 14. In a situation where the control device A1 is connected to a game console, a computer, or other device through the electrical connection wire, the two gripping parts 1 are configured to obtain the electrical power required for operation through the electrical connection wire, and are also configured to transmit signals with the game console, the computer, or other devices through the electrical connection wire.

In different embodiments, when the power supply module 2 and the two gripping parts 1 are engaged with each other, and the electrical connector 14 of the gripping part 1 is connected to the external power supply equipment through the electrical connection wire, the rechargeable battery 23 of the power supply module 2 is also configured to be charged.

According to the above, the control device A1 of the present disclosure is designed so that each of the gripping parts 1 has the gripping engaging structure 12 and the gripping electrical connection structure 13, and the power supply module 2 has the power supply electrical connection structure 24 and the auxiliary engaging structure 22. The configuration allows the user to conveniently and quickly connect the two gripping parts 1 with the power supply module 2, thereby forming a full-sized wireless control grip. The user can then utilize the full-sized wireless control grip to connect to various game consoles, computers, and other devices.

By the design of the electrical connector 14 of the gripping part 1, the user can connect the control device A1 to devices such as game consoles, computers, and other devices through the electrical connection wire. The electrical power required for the operation of the control device A1 is also configured to be obtained through the electrical connection wire and the electrical connector 14. Furthermore, the control device A1 is configured to transmit relevant control signals to the game console, computer, and other devices through the electrical connection wire. In other words, when the two gripping parts 1 are connected through the power supply module 2, the user can also use the electrical connection wire to connect the control device A1 to game consoles, computers, and other devices in a wired manner.

In the present embodiment, when the electrical connection wire is connected to the game console (or the computer, etc.), the operating member 11 is operated, and the resulting control signals are transmitted to the game console through the electrical connection wire. Naturally, if the electrical connection wire is connected only to a device that merely supplies power, such as the power bank, the control signals generated by the gripping parts 1 are transmitted wirelessly to the devices such as game consoles, computers, smartphones, tablets, and other devices.

In practice, a processing module 15 is disposed in one of the gripping parts 1. The processing module 15 is configured to determine whether the device connected to the power supply module 2 through the electrical connection wire is configured to receive the control signals generated by the operation of each of gripping parts 1. If the processing module 15 determines that the device connected through the electrical connection wire only has a power supply function, the processing module 15 is configured to transmit the control signals wirelessly. Naturally, before transmitting the control signals wirelessly, the processing module 15 is operable to first establish a wireless connection with the external device (e.g., a smartphone, tablet, game console, computer, etc.).

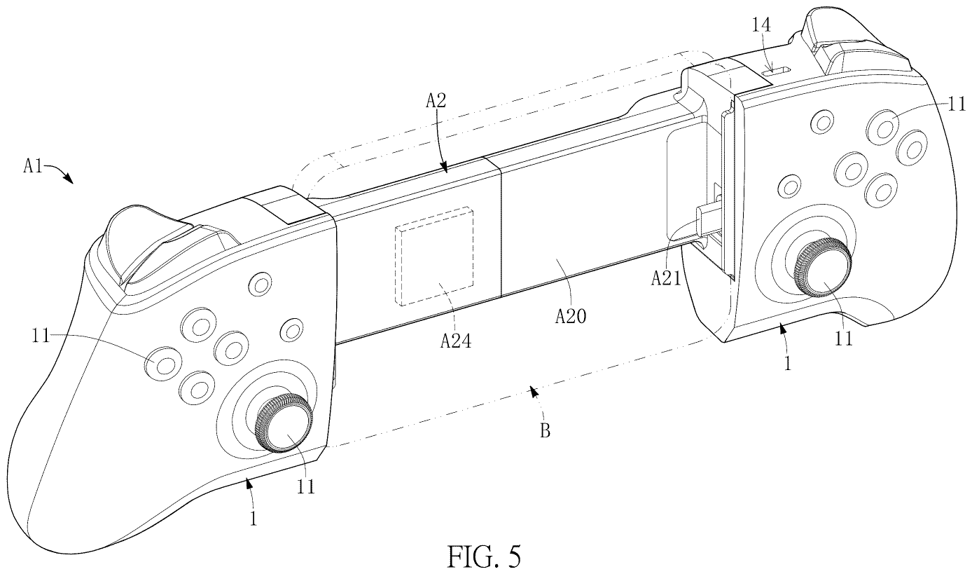

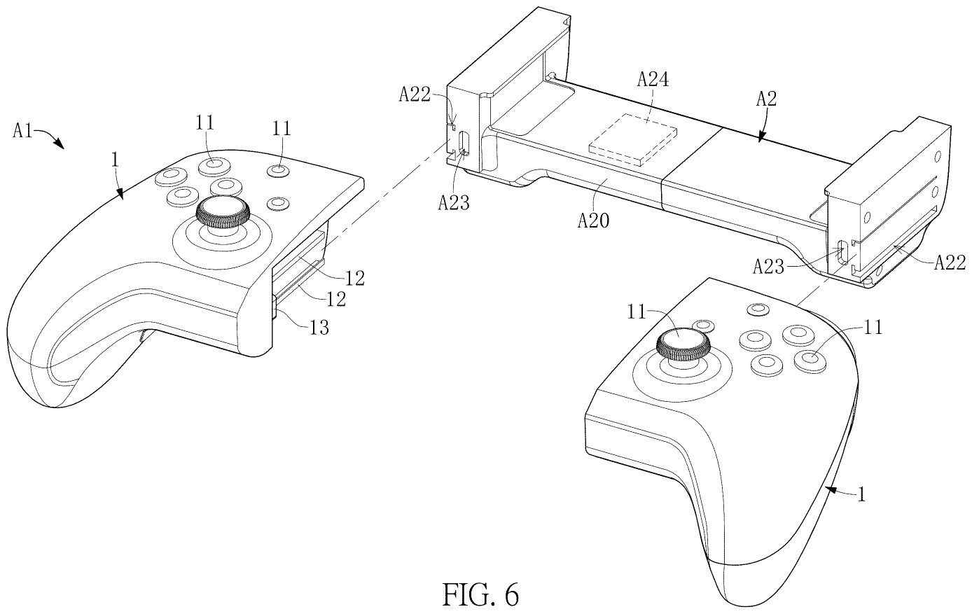

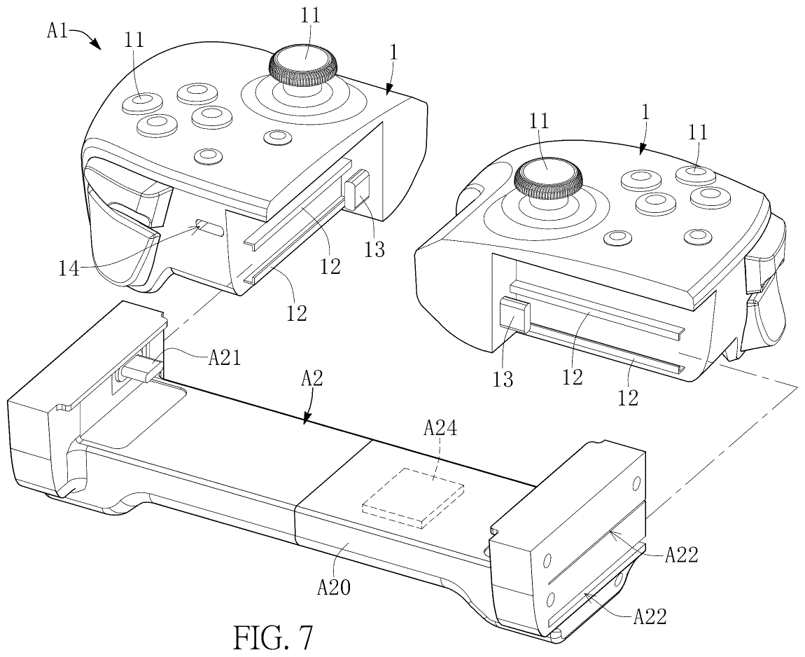

Reference is made to FIG. 5 to FIG. 7, in which FIG. 5 is a schematic view showing an assembly of the two gripping parts and the support plate of the control device according to the present disclosure. FIG. 6 and FIG. 7 are schematic exploded views of the two gripping parts and the support plate of the control device from different perspectives according to the first embodiment of the present disclosure.

The two gripping engaging structures 12 of the two gripping parts 1 of the control device A1 of the present disclosure are also respectively engaged with plate engaging structures A22 provided on both sides of a support plate A2, and the two gripping parts 1 are configured to be connected to each other through the plate engaging structures A22. After the two gripping parts 1 and the support plate A2 are connected to each other, the two gripping parts 1 and the support plate A2 are configured to jointly hold an electronic device B. The electronic device B is, for example, a smart phone, a tablet computer, etc., but the present disclosure is not limited thereto.

The support plate A2, for example, includes a support body A20, an internal connector A21, two plate engaging structures A22, two external connectors A23 and a processing module A24. The plate engaging structures A22 are respectively disposed on both sides of the support plate A20. The internal connector A21 is disposed at one side of the support body A20, and the internal connector A21 is configured for plugging with the electrical connector of the electronic device B. The processing module A24 is disposed in the support body A20 and is electrically connected to the internal connector A21 and the two external connectors A23. The two external connectors A23 are disposed at the both ends of the support body A20, and each of the external connectors A23 is disposed adjacent to each of the plate engaging structures A22.

When the two plate engaging structures A22 of the support plate A2 and the two gripping engaging structures 12 of the two gripping parts 1 are engaged with each other, the two external connectors A23 and the two gripping electrical connection structures 13 are connected to each other, and after the operating members 11 of each gripping part 1 are operated, the resulting operation signals are transmitted to the processing module A24 through the gripping electrical connection structures 13 and the external connectors A23. The processing module A24 is configured to transmit the operation signals to the electronic device B through the internal connector A21. Similarly, the electronic device B is also configured to transmit signals to internal processors of each of the gripping parts 1 through the internal connector A21, the external connector A23, and the gripping electrical connection structure 13.

It should be noted that, in the present embodiment, for example, the two gripping engaging structures 12 of the two gripping parts 1 and the two plate engaging structures A22 of the support plate A2 are configured to be engaged with each other, and the two gripping engaging structures 12 and the two auxiliary engaging structures 22 of the power supply module 2 are also configured to be engaged with each other, the present disclosure is not limited thereto. In different embodiments, each of the gripping parts 1 can have two different types of the engaging structures, one of the engaging structures is for engaging with the plate engaging structure A22, and another one of the engaging structures is for engaging with the auxiliary engaging structure 22.

It should be noted that, after the two gripping parts 1 are connected to the support plate A2, the electrical power required for the operation of the two gripping parts 1 can be obtained from the electronic device B through the gripping electrical connection structure 13, the external connector A23, the internal connector A21, and the connector of the electronic device B. Naturally, when the electrical connector 14 of the gripping part 1 is connected to an external power supply device (e.g., a power bank) through the electrical connection wire, the electrical power required for the operation of the gripping parts 1 can be supplied by the external power supply device through the electrical connection wire.

In one of the variant embodiments, a rechargeable battery is also configured to be disposed inside the support plate A2, and the rechargeable battery is configured to supply the electrical power to the two gripping parts 1 through the external connector A23. The support plate A2 further has a charging electrical connector. The charging electrical connector is configured to be connected to an external power source through the electrical connection wire, such that the external power source is configured to charge the rechargeable battery inside the support plate A2.

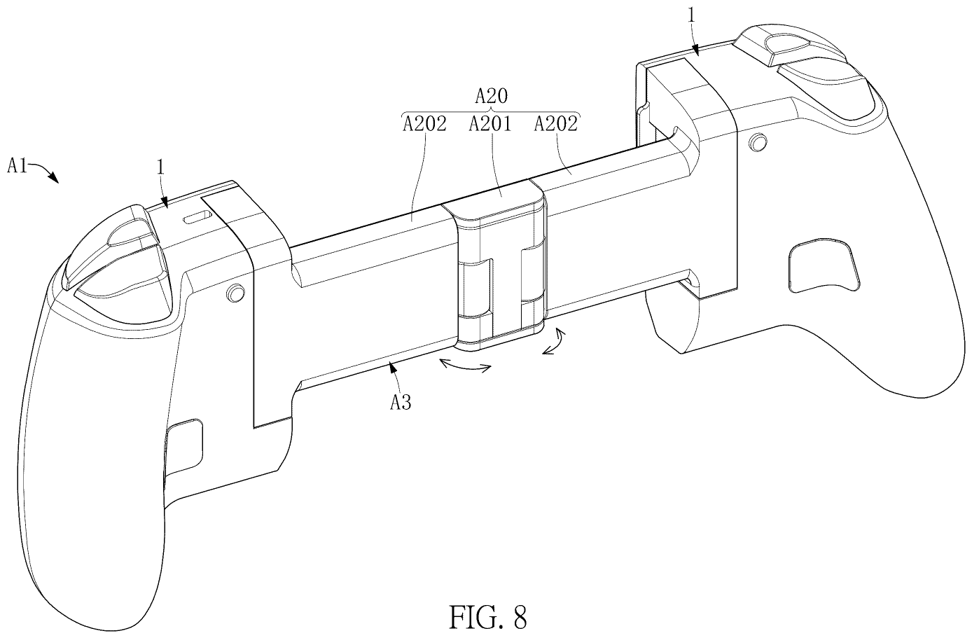

Reference is made to FIG. 8, which is a schematic view showing an assembly of the two gripping parts and the support plate of a second embodiment of the control device according to the present disclosure. The main difference between the support plate A3 of the present embodiment and the support plate described in the previous embodiment is as follows: the support body A20 of the support plate A3 includes a rotating shaft mechanism A201 and two support parts A202. The two support parts A202 are connected through the rotating shaft mechanism A201, and any one of the support parts A202 is configured to be operated to rotate relative to another one of the support parts A202. With this design, the user can rotate one of the gripping parts 1 toward the another one of the gripping parts 1 according to requirements, thereby facilitating storage.

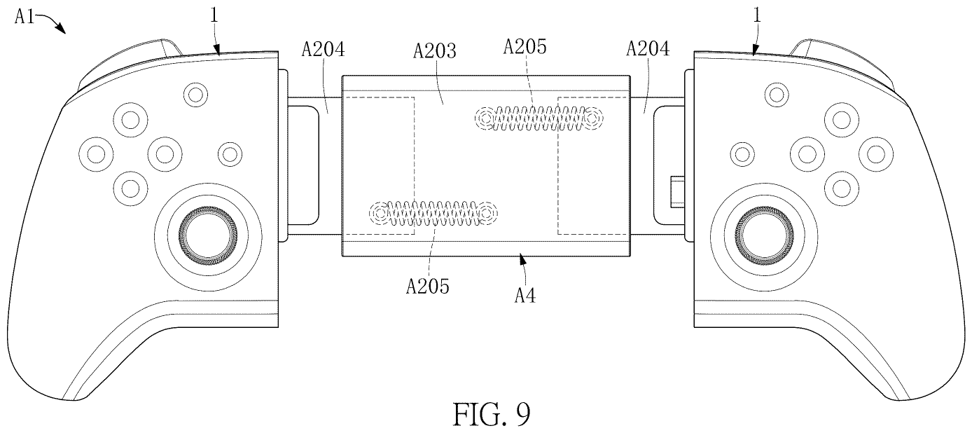

Reference is made to FIG. 9, which is a schematic view showing an assembly of the two gripping parts and the support plate of a third embodiment of the control device according to the present disclosure. The difference between the support plate A4 of this embodiment and those of the aforementioned embodiments is as follows: the support body A20 of the support plate A4 includes an intermediate member A203, two telescopic members A204, and a plurality of elastic members A205. One end of one of the telescopic members A204 is movably connected to one end of the intermediate member A203, and one end of another one of the telescopic members A204 is movably connected to another one end of the intermediate member A203.

Both ends of one of the elastic members A205 are respectively connected to one of the telescopic members A204 and one of the intermediate members A203, and both ends of another one of the elastic members A205 are respectively connected to another one of the telescopic members A204 and another one of the intermediate members A203. When the two gripping parts 1 are operated and moved away from each other, the two elastic members A205 are elastically deformed. When the two gripping parts 1 are no longer operated, the elastic force generated by the elastic deformation of the elastic members A205 causes the two gripping parts 1 to move toward each other.

According to the above, the support plate A4 of the present embodiment, through the design of the intermediate member A203, telescopic members A204, and elastic members A205, allows the control device A1 to securely hold electronic devices of different sizes, such as smartphones, tablets, etc.

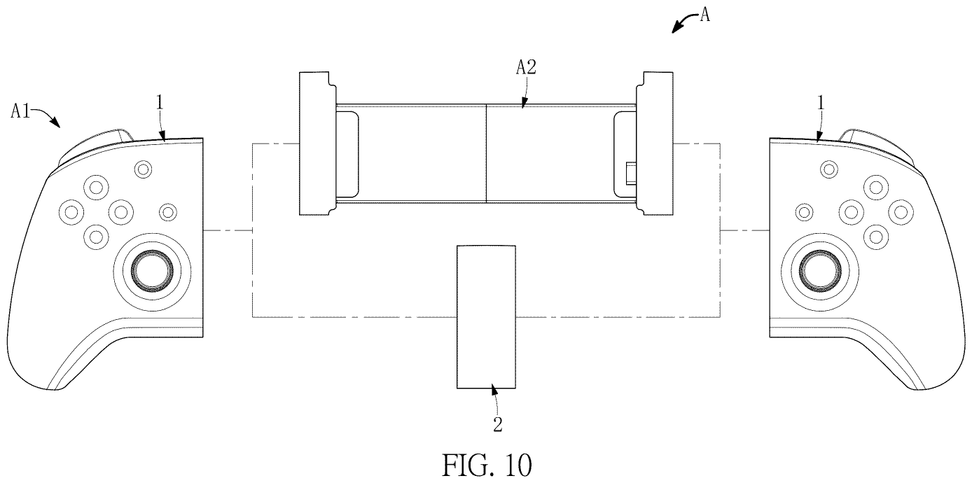

Reference is made to FIG. 10, which is a schematic view of a control device kit according to the present disclosure. The control device kit D of the present disclosure includes two gripping parts 1, a power supply module 2 and a support plate A2. The control device kit D is sold to include the two gripping parts 1, the power supply module 2, and the support plate A2 together as a set. After purchasing the control device kit D, a consumer can selectively connect the two gripping parts 1 to the power supply module 2 or to the support plate A2 according to their needs. For the connection relationships among the gripping parts 1, the power supply module 2, and the support plate A2, as well as their various modified forms, reference can be made to the description of the aforementioned embodiments, which will not be repeated herein.

In other words, after purchasing the control device kit D of the present disclosure, if the user intends to play games using a television, monitor, or similar display, the user can connect the two gripping parts 1 to the power supply module 2 to obtain a full-sized control grip. If the user intends to play games on a smartphone or tablet, the two gripping parts 1 can be connected to the support plate A4, and together the two gripping parts 1 and the support plate A4 can securely hold the smartphone or tablet.

In summary, the control device and the control device kit of the present disclosure, through the detachable connection design between the two gripping parts and the power supply module, enable the control device to comply with relevant European battery regulations, and allow users to conveniently and quickly replace the battery. In addition, the design allowing the two gripping parts to be detached from the power supply module also facilitates convenient storage for the user.

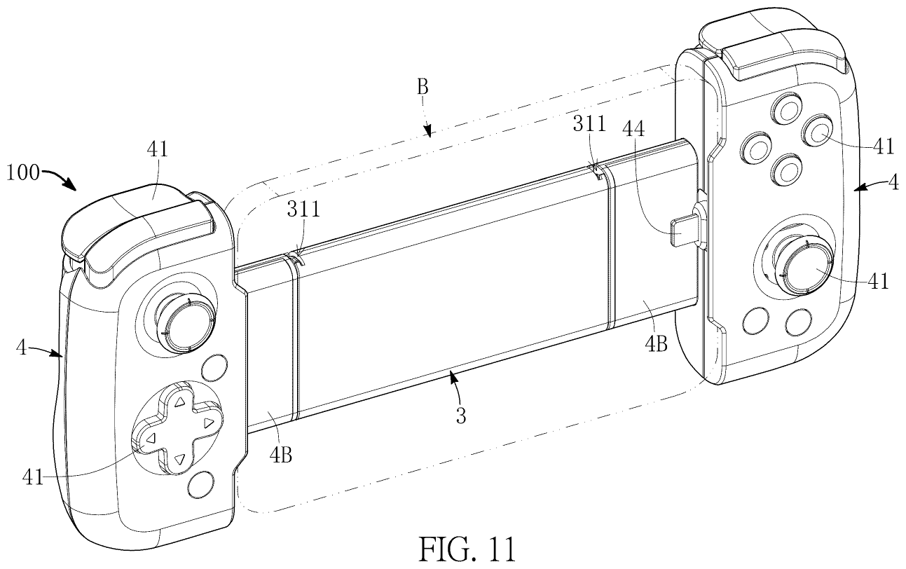

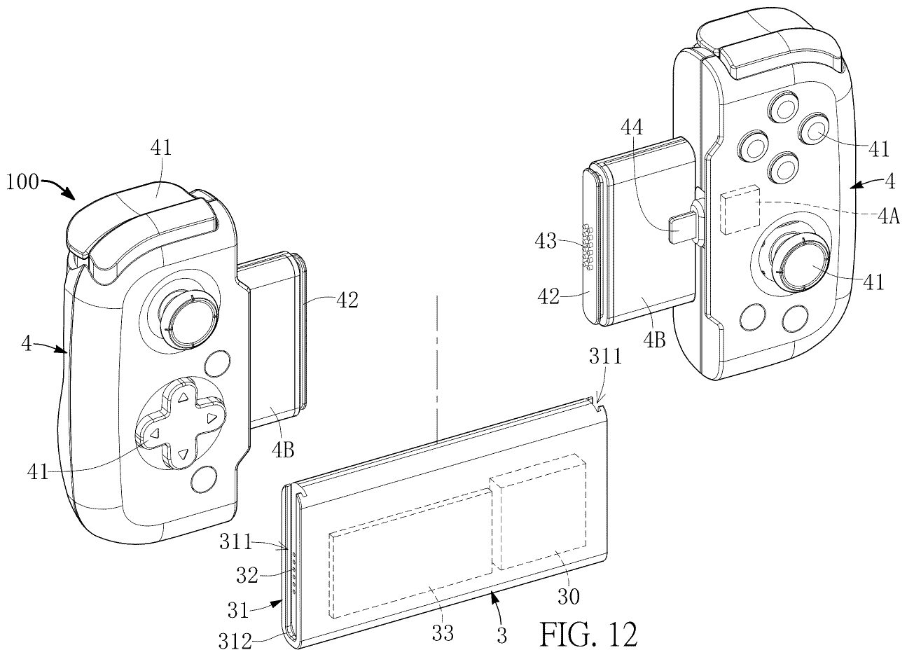

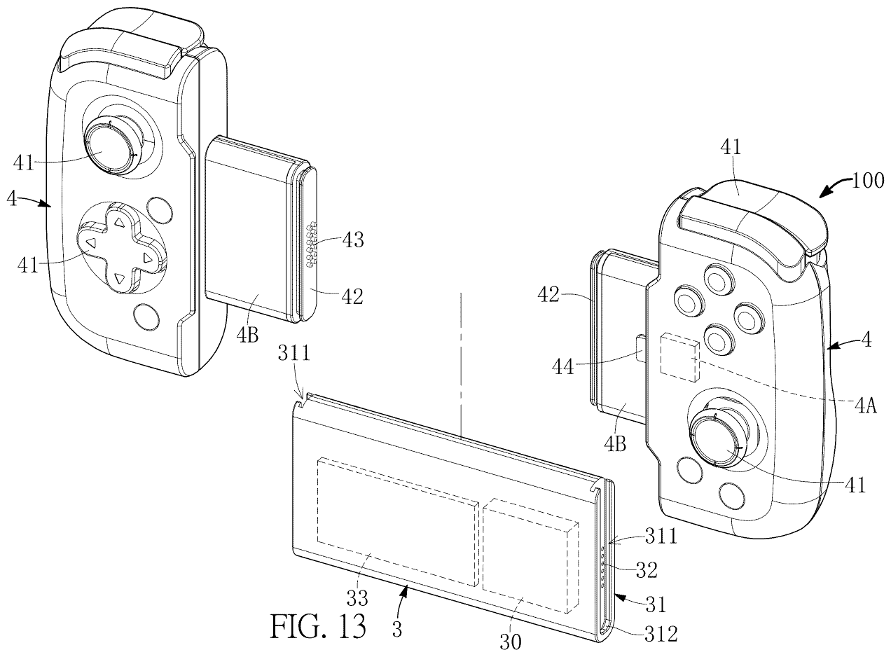

Reference is made to FIG. 11 to FIG. 13, in which FIG. 11 is a schematic view of the control device according to a fourth embodiment of the present disclosure, and FIG. 12 and FIG. 13 are schematic exploded views of the control device from different perspectives, respectively, according to the fourth embodiment of the present disclosure.

A control device 100 of the present disclosure is configured to hold an electronic device B and is connected to the electronic device B. The control device 100 includes a support plate 3 and two gripping parts 4. Two opposite ends of the support plate 3 respectively have a first engaging structure 31 and a first electrically connecting structure 32, the support plate 3 is not provided with a display. The support plate 3 includes a circuit module 33, and each of the first electrically connecting structures 32 is connected to the circuit module 33.

Each of the gripping parts 4 has a plurality of operating members 41, an inside of each of the gripping parts 4 has a second engaging structure 42, and the inside of at least one of the gripping parts 4 has a second electrically connecting structure 43. In the drawings of the present embodiment, the inner side of each gripping part 4 has a protruding part 4B, one end of the protruding part 4B is fixed to the inner side of the gripping part 4, and another one end of the protruding part 4B is provided with a second engaging structure 42. Size of the protruding part 4B is not limited to that shown in the drawings. In different embodiments, the gripping part 4 can also be without the protruding part 4B.

The inside of one of the gripping parts further includes a connector 44. The connector 44 is configured to be connected to a mating connector 44 of the electronic device B, and control signals generated by operation of each of the operating member 41 are configured to be transmitted to the electronic device B through the connector 44 and the mating connector 44. The connector 44 can be various types of USB connectors, such as a Type-C connector, but the actual type of connector 44 can be varied according to requirements. The operating members 41 of each gripping part 4 can be designed as buttons, joysticks, touchpads, or the like according to actual requirements, and are not limited herein.

The two second engaging structures 42 of the two gripping parts 4 are configured to be detachably connected to the two first engaging structures 31 of the support plate 3.

In one specific application, each of the first engaging structures 31 is a sliding groove, and the first electrically connecting structure 32 is located in the sliding groove. One end of the sliding groove has an opening 311, and another one end of the sliding groove has an enclosed portion 312. The second engaging structure 42 is a protruding structure. The protruding structure is configured to slide into the sliding groove through the opening 311, and the protruding structure is configured to abut against the enclosed portion 312 so as to restricted by the enclosed portion 312.

When the two second engaging structures 42 of the two gripping parts 4 are engaged with the two first engaging structures 31 of the support plate 3, the first electrically connecting structure 32 is configured to be electrically connected to the second electrically connecting structure 43, and the two gripping parts 4 are configured to be electrically connected through the circuit module 33 disposed in the support plate 3.

In one specific example, a central processing module 4A is disposed in the gripping part 4 that is provided with the connector 44. The central processing module 4A is configured to transmit signals to the electronic device B through the connector 44. That is to say, control signals generated by the two gripping parts 4 are transmitted through the central processing module 4A and delivered to the electronic device B through the connector 44. In other words, when the gripping part 4 without a connector 44 is operated by the user and generates corresponding control signals, the control signals can be transmitted through the circuit module 33 in the support plate 3 to the central processing module 4A in the gripping part 4 equipped with the connector 44. It is worth mentioning that, through the arrangement of the circuit module 33, the electronic device B can also supply the electrical power to the two gripping parts 4 through the connector 44, the central processing module 4A, and the circuit module 33.

In different embodiments, the gripping part 4 without a connector 44 is also configured to be wirelessly connected with the gripping part 4 equipped with the connector 44 to transmit the control signals.

In one specific embodiment, at least one battery 30 is disposed in the support plate 3. When the first electrically connecting structure 32 is electrically connected to the second electrically connecting structure 43, the battery 30 is configured to provide the electrical power required for each of the gripping parts 4 to operate. In the example where the support plate 3 is equipped with the battery 30, when the user finds that the gripping part 4 has insufficient electrical power, the user can replace the support plate 3 with one that has a higher power capacity, thereby allowing the gripping part 4 to be charged. Naturally, the support plate 3 can also include a power indicator and a charging port. The power indicator is configured to display the current power level of the battery 30 in the support plate 3. The power indicator can, for example, include a plurality of light-emitting units, where different power levels of the battery correspond to different numbers of light-emitting units being lit. The user can also use the charging port to connect the support plate 3 to an external power source through the connection wire, thereby allowing the external power source to charge the battery 30.

Similar to the example shown in FIG. 8 above, in one of the variations of the present embodiment, the support plate 3 further includes a rotating shaft mechanism and two support parts. The two support parts are connected through the rotating shaft mechanism, and any one of the support parts is configured to be operated to rotate relative to another one of the support parts. With this design, after the user connects the support plate 3 with the two gripping parts 4, the user can rotate the two gripping parts 4 toward each other through the rotating shaft mechanism, thereby facilitating the storage of the control device. Similarly, when storing the support plate 3, the user can rotate the two support parts toward the rotating shaft mechanism, thereby shortening the overall length of the support plate 3 to facilitate storage.

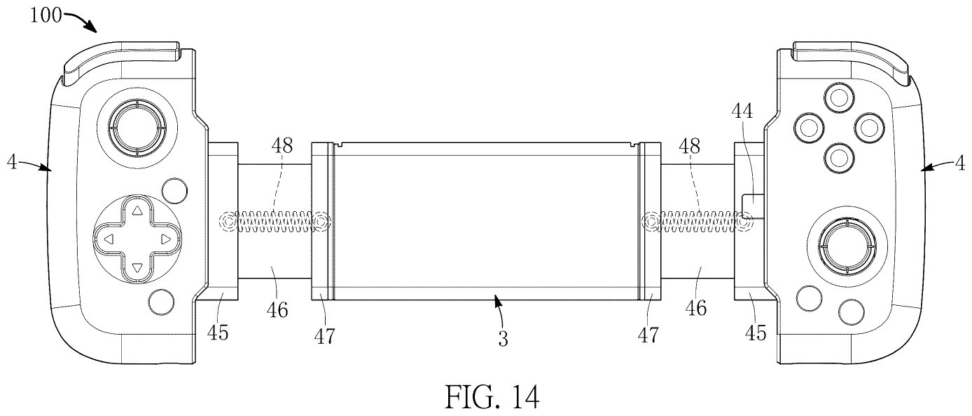

Reference is made to FIG. 14, which is a schematic view of the control device according to a fifth embodiment of the present disclosure. The biggest difference between this embodiment and the above-mentioned embodiments is that: the inner side of each of the gripping parts 4 includes a fixed part 45, a telescopic structure 46, an end portion 47, and at least one elastic member 48. One end of the fixed part 45 is fixed to the inner side of the gripping part 4, and another end of the fixed part 45 is connected to one end of the telescopic structure 46, and another end of the telescopic structure 46 is connected to the end portion 47. The telescopic structure 47 is configured to move telescopically relative to the fixed part in a direction away from the gripping part 4. The two ends of the elastic member 48 are fixed to the fixed part 45 and the telescopic structure 46 (or the end portion 47), when the telescopic structure 46 is moved away from the gripping part 4, the elastic member 48 undergoes elastic deformation.

The end portion 47 is opposite to the end connected to the telescopic structure 46 and has a second engaging structure 42 and a second electrically connecting structure 43. Any one of the gripping parts 4 can be operated to move away from another one of the gripping parts 4, causing the elastic member 48 to be stretched and elastically deformed. Through the above design, the control device 100 can securely hold electronic devices B of different sizes. It should be noted that, the present embodiment can also be combined with the aforementioned second embodiment to form a new embodiment.

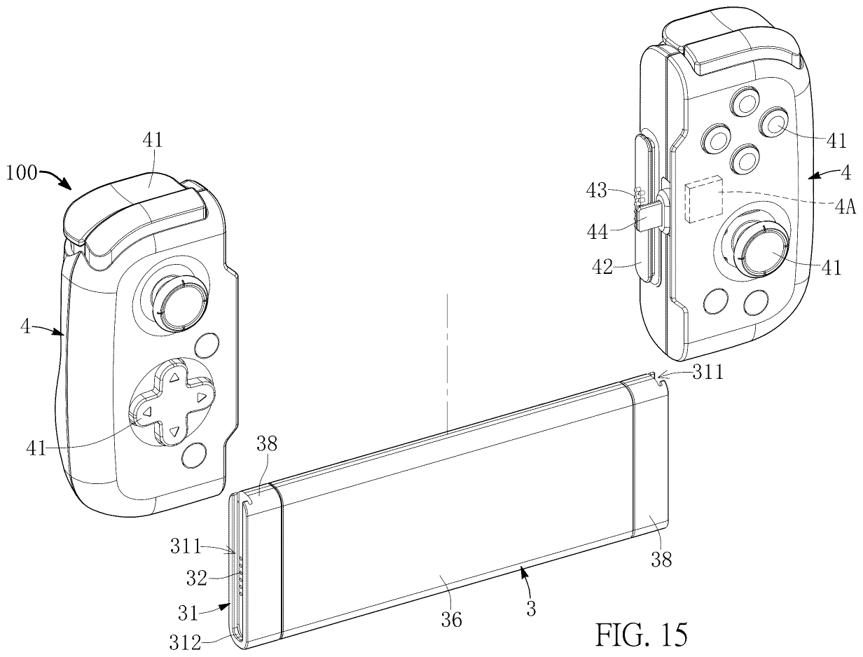

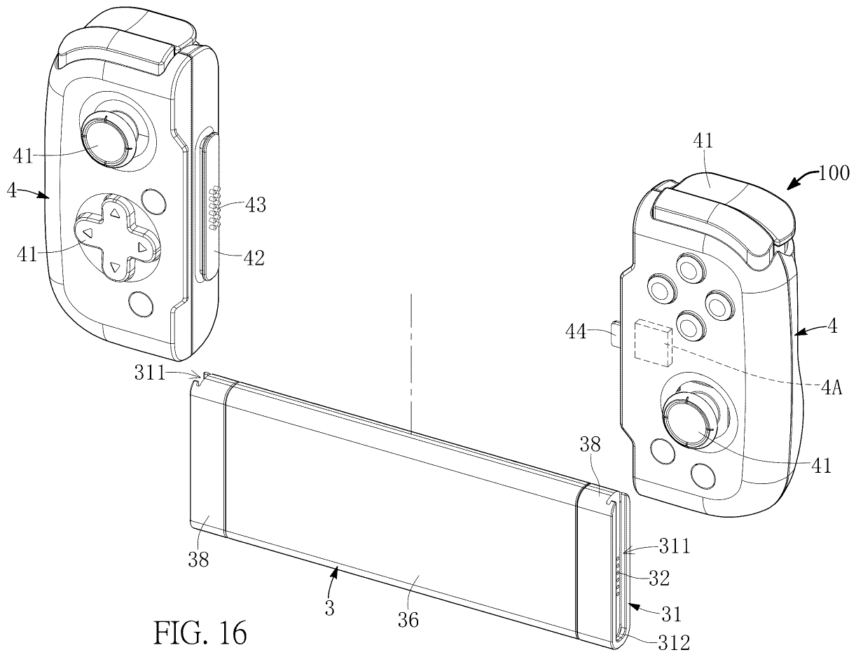

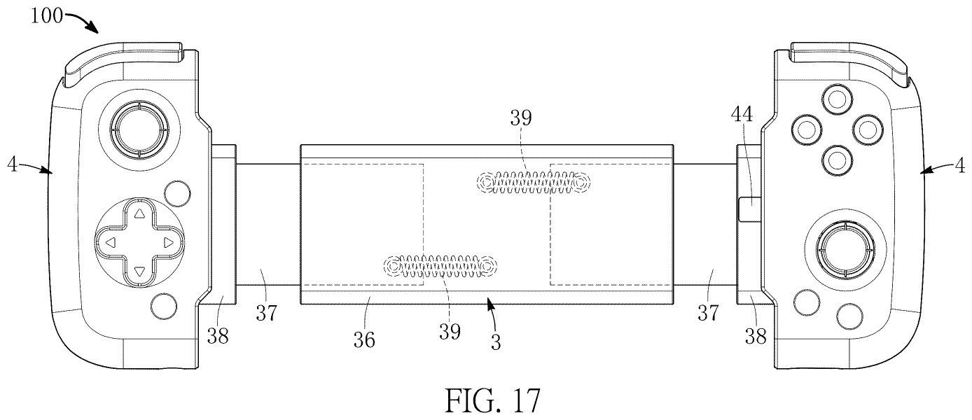

Reference is made to FIG. 15 to FIG. 17, in which FIG. 15 and FIG. 16 are schematic exploded views of the control device from different perspectives, respectively, according to a sixth embodiment of the present disclosure, and FIG. 17 is a schematic view of the control device according to the sixth embodiment of the present disclosure.

The main difference between the present embodiment and the embodiment shown in FIG. 11 is that: the support plate 3 includes an intermediate member 36, two telescopic members 37, two end portions 38, and a plurality of elastic members 39. Both ends of the intermediate member 36 are connected to the two telescopic members 37, and each of the two telescopic members 37 is configured to telescopically move relative to the intermediate member 36. Another end of each of the two telescopic members 37 is connected to the end portions 38, and the end portion 38 is opposite to the end connected to the telescopic member 37 and has the first engaging structure 31 and the first electrically connecting structure 32. Both ends of each of the elastic members 39 are respectively connected to the intermediate member 36 and the telescopic member 37.

When both ends of the support plate 3 are fixed to the two gripping parts 4, the user can pull the two gripping parts 4 away from each other, causing the two telescopic members 37 to move away from each other relative to the intermediate member 36, and the elastic members 39 to be elastically deformed. Each of the elastic members 39 can, for example, be a spring, a leaf spring, or other components, but the present disclosure is not limited thereto. Through the above design, the control device 100 can be used to securely hold electronic devices B of various sizes. In one variant of this embodiment, the support plate 3 can also be without the elastic members 39.

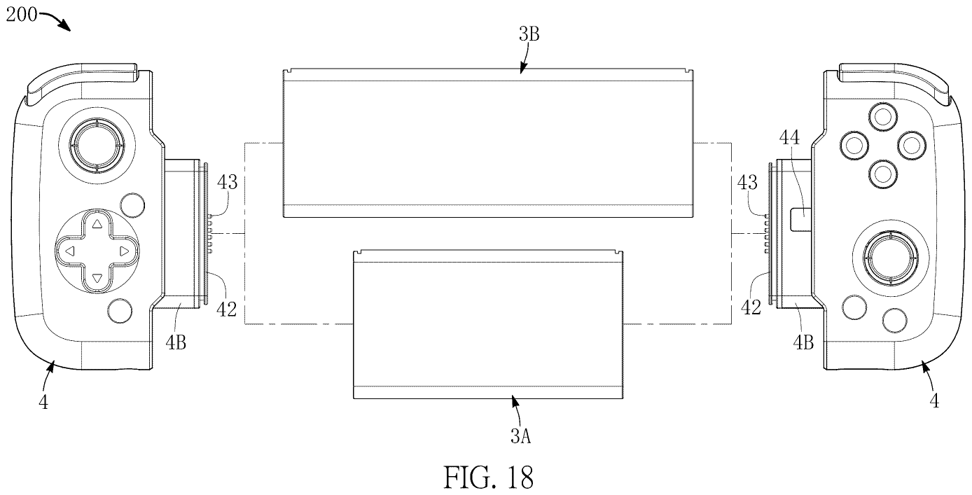

Reference is made to FIG. 18, which is a schematic view of a control device kit according to another embodiment of the present disclosure. The control device kit 200 of the present disclosure includes two support plates 3A, 3B, and two gripping parts 4. The two support plates 3A, 3B have different widths. Each of the support plates 3 can be the same as the support plate 3 described in any of the preceding embodiments. The gripping parts 4 of the present embodiment are the same as those in the aforementioned embodiments and will not be further described herein.

According to the above, after purchasing the control device kit 200 of the present disclosure, the user can select different support plates 3A, 3B according to the actual size of the electronic device to be held. For example, by connecting the narrower support plate 3A with the two gripping parts 4, the user can securely hold relatively small electronic devices such as smartphones. Conversely, by connecting the wider support plate 3B with the two gripping parts 4, the user can securely hold larger electronic devices such as tablets.

In summary, the control device and the control device kit of the present disclosure, through a detachable design between the intermediate member and the two gripping parts, the user can replace the intermediate member with different widths according to the size of the electronic device to be held, thereby enhancing user convenience.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A control device, comprising:
two gripping parts, wherein each of the gripping parts has a plurality of operating members, an inside of each of the gripping parts has a gripping engaging structure and a gripping electrical connection structure, and no power supply unit is disposed inside each of the gripping parts; and
a power supply module including a main body, a rechargeable battery, at least one power supply electrical connection structure, and an external electrical connection structure; wherein two opposite sides of the main body each have an auxiliary engaging structure, the rechargeable battery is disposed in the main body, the at least one power supply electrical connection structure is disposed on the main body and is electrically connected to the rechargeable battery, and the external electrical connection structure is configured to connect an external power supply device, such that the external power supply device is configured to charge the rechargeable battery;
wherein the gripping engaging structure of each of the gripping parts and the auxiliary engaging structure are configured to be engaged with each other, and the gripping electrical connection structure and the power supply electrical connection structure are configured to be engaged with each other, such that the two gripping parts are configured to obtain electrical power provided by the rechargeable battery;
wherein the two gripping engaging structures of the two gripping parts are configured to be engaged with the plate engaging structures that are respectively disposed on both sides of a support plate, the two gripping parts are configured to be engaged with each other through the plate engaging structures, and the two gripping parts and the support plate are configured to jointly hold an electronic device.

2. The control device according to claim 1, wherein the two gripping parts have different colors; and wherein each of the gripping engaging structures is a rail structure, and each of the auxiliary engaging structures is a sliding groove structure; or each of the gripping engaging structures is a sliding groove structure, and each of the auxiliary engaging structures is a rail structure.

3. The control device according to claim 1, wherein an electrical connector is disposed on at least one of the gripping parts, the electrical connector is configured to be connected to an electrical connection wire, and the gripping part is configured to obtain the electrical power, transmit information, or receive information through the electrical connection wire, wherein the electrical power is obtained by the electrical connector through the electrical connection wire, and the electrical power is configured to be transmitted to another gripping part through the power supply module, and wherein the electrical power required for operation of the two gripping parts is configured to be obtained through the electrical connector and the electrical connection wire.

4. The control device according to claim 1, wherein a switch unit and an electrical quantity display unit are disposed on the main body of the power supply module, wherein the switch unit is configured to be operated by the user, so as to enable or disable the rechargeable battery to start or stop supplying the electrical power to the two gripping parts, and wherein the electrical quantity display unit is configured to display electrical quantity of the rechargeable battery.

5. A control device kit, comprising:
two gripping parts, wherein each of the gripping parts has a plurality of operating members, an inside of each of the gripping parts has a gripping engaging structure, the inside of at least one of the gripping parts has a gripping electrical connection structure, and no power supply unit is disposed inside each of the gripping parts;
a power supply module including a main body, a rechargeable battery, and at least one power supply electrical connection structure, wherein two opposite sides of the main body each have an auxiliary engaging structure, the rechargeable battery is disposed in the main body, and the at least one power supply electrical connection structure is disposed on the main body and is electrically connected to the rechargeable battery;
a support plate, wherein both sides of the support plate respectively have a plate engaging structure, the two gripping engaging structures of the two gripping parts are configured to be engaged with the two plate engaging structures; wherein the two gripping parts and the support plate that are connected to each other are configured to jointly hold an electronic device;
wherein the gripping engaging structure of each of the gripping parts and the auxiliary engaging structure are configured to be engaged with each other, and the gripping electrical connection structure and the power supply electrical connection structure are configured to be engaged with each other, such that the two gripping parts are configured to obtain electrical power provided by the rechargeable battery.

6. A control device configured to hold an electronic device and connected to the electronic device, the control device comprising:
a support plate, wherein two opposite ends of the support plate respectively have a first engaging structure and a first electrically connecting structure, the support plate is not provided with a display; the support plate includes a circuit module, and each of the first electrically connecting structures is connected to the circuit module; and
two gripping parts, wherein each of the gripping parts has a plurality of operating members, an inside of each of the gripping parts has a second engaging structure, the inside of at least one of the gripping parts has a second electrically connecting structure, the inside of one of the gripping parts further includes a connector, and the connector is configured to be connected to a mating connector of the electronic device; and wherein control signals generated by operation of each of the operating members are configured to be transmitted to the electronic device through the connector and the mating connector;
wherein the two second engaging structures of the two gripping parts are configured to be detachably connected to the two first engaging structures of the support plate; and wherein, when the two second engaging structures of the two gripping parts are engaged with the two first engaging structures of the support plate, the first electrically connecting structure is configured to be electrically connected to the second electrically connecting structure.

7. The control device according to claim 6, wherein the support plate includes a rotating shaft mechanism and two support parts, the two support parts are connected through the rotating shaft mechanism, and any one of the support parts is configured to be operated to rotate relative to another one of the support parts.

8. The control device according to claim 6, wherein the support plate includes an intermediate member, two telescopic members, two end portions, and a plurality of elastic members, both ends of the intermediate member are connected to one end of each of the two telescopic members, and each of the two telescopic members is configured to telescopically move relative to the intermediate member, and another end of each of the two telescopic members is connected to one end of one of the end portions; wherein both ends of each of elastic members are respectively connected to the telescopic member and the intermediate member, the first engaging structure and the first electrically connecting structure are disposed on another end of each of the end portions; and wherein, when the two telescopic members move away from the intermediate member, each of the elastic members is elastically deformed.

9. The control device according to claim 6, wherein at least one battery is disposed in the support plate; and wherein, when the first electrically connecting structure is electrically connected to the second electrically connecting structure, the battery is configured to provide the electrical power required for the gripping parts to operate.

10. The control device according to claim 6, wherein each of the gripping parts includes a fixed part, a telescopic structure, an end portion, and at least one elastic member, one end of the fixed part is fixed to the inner side of the gripping part, and another end of the fixed part is connected to one end of the telescopic structure, and another end of the telescopic structure is connected to the end portion, wherein the telescopic structure is configured to move telescopically relative to the fixed part in a direction away from the gripping part, and wherein the two ends of the elastic member are fixed to the fixed part and the telescopic structure, and when the telescopic structure is moved away from the gripping part, the elastic member is elastically deformed.

11. The control device according to claim 6, wherein the first engaging structure is a sliding groove, the first electrically connecting structure is located in the sliding groove, one end of the sliding groove has an opening, and another end of the sliding groove has an enclosed portion; and wherein the second engaging structure is a protruding structure, the protruding structure is configured to slide into the sliding groove through the opening, and the protruding structure is configured to abut against the enclosed portion so as to be restricted by the enclosed portion.

12. A control device kit, comprising:
two support plates, wherein two opposite ends of each of the support plates respectively have a first engaging structure and a first electrically connecting structure, the support plate is not provided with a display, the support plate includes a circuit module, and each of the first electrically connecting structures is connected to the circuit module; wherein widths of the two support plates are different; and
two gripping parts, wherein each of the gripping parts has a plurality of operating members, an inside of each of the gripping parts has a second engaging structure, the inside of at least one of the gripping parts has a second electrically connecting structure, wherein, when the two gripping parts and one of the support plates are connected to each other, the two gripping parts and the support plate are configured to jointly hold an electronic device; wherein the inside of one of the gripping parts further includes a connector, and the connector is configured to be connected to a mating connector of the electronic device; and wherein control signals generated by operation of each of the operating members are configured to be transmitted to the electronic device through the connector and the mating connector;
wherein the two second engaging structures of the two gripping parts are configured to be detachably connected to the two first engaging structures of the support plate; and wherein, when the two second engaging structures of the two gripping parts are engaged with the two first engaging structures of the support plate, the first electrically connecting structure is configured to be electrically connected to the second electrically connecting structure.
